(19) United States
(12) Patent Application Publication
(10) Pub. No.: US 2016/0371329 A1
(43) Pub. Date: Dec. 22, 2016

(54) PREPARED EXECUTION PLANS FOR JOINS WITH PARTITIONED TABLES

(71) Applicant: SAP SE, Walldorf (DE)

(72) Inventors: Christian Bensberg, Heidelberg (DE); Wolfgang Stephan, Heidelberg (DE); Robin Joy, Walldorf (DE); Adrian Dragusanu, Dublin, CA (US)

(21) Appl. No.: 14/746,193

(22) Filed: Jun. 22, 2015

(51) Int. Cl. G06F 17/30

(52) U.S. Cl. CPC G06F 17/30463; G06F 17/30498

(57) ABSTRACT

A computer-implemented method for preparing and executing a plan for a query containing joins against one or more tables having multiple partitions includes receiving a query containing joins to execute against one or more tables in a database, where at least one of the tables includes multiple partitions. Prior to executing the query, the method includes preparing a plan to join the multiple partitions using paths between the joined partitions and storing the plan in a cache. During execution of the query, the method includes analyzing one or more clauses of the query to determine which of the joined partitions to prune from the plan, removing from the plan the paths connecting the pruned partitions and executing the plan without the pruned partitions to return a result to the query.

### TECHNICAL FIELD

This description relates to prepared execution plans for joins with partitioned tables.

### BACKGROUND

A database may include one or more tables containing data. The tables may be non-partitioned tables and/or partitioned. When a query is received to obtain data from the tables, systems and techniques are desirable to prepare a plan for executing the query and to execute the query in an efficient and cost effective manner.

### SUMMARY

According to one general aspect, a computer-implemented method for preparing and executing a plan for a query containing joins against one or more tables having multiple partitions includes receiving a query containing joins to execute against one or more tables in a database, where at least one of the tables includes multiple partitions. Prior to executing the query, the method includes preparing a plan to join the multiple partitions using paths between the joined partitions and storing the plan in a cache. During execution of the query, the method includes analyzing one or more clauses of the query to determine which of the joined partitions to prune from the plan, removing from the plan the paths connecting the pruned partitions and executing the plan without the pruned partitions to return a result to the query.

According to another general aspect, a computer-implemented method for preparing and executing a plan for a query containing joins against one or more tables having multiple partitions, where one or more of the partitions are stored on disk-based storage includes receiving a query containing joins to execute against one or more tables in a database, where at least one of the tables include multiple partitions and one or more of the partitions are stored on disk-based storage. Prior to executing the query, the method includes analyzing one or more clauses of the query to determine which of the partitions to include in a plan to join one or more of the partitions using paths between the joined partitions, preparing the plan only for the partitions needed to execute the query and storing the plan in a cache including information on which of the partitions were included in the plan. The method includes executing the plan to return a result to the query.

In another general aspect, a system for preparing and executing a plan for a query containing joins against one or more tables having multiple partitions, where one or more of the partitions are stored on disk-based storage includes a database. The database includes one or more tables having multiple partitions, memory modules storing one or more of the multiple partitions of the tables, a disk-based storage device storing one or more of the multiple partitions of the tables, a query processor configured to receive a query containing joins to execute against at least one of the tables, a plan cache that is operably coupled to the query processor and that is configured to store a plan to join one or more of the partitions using paths between the joined partitions and a join engine that is operably coupled to the disk-based storage, the memory modules, and the query processor. The join engine is configured to analyze one or more clauses of the query to determine which of the partitions are needed to execute the query. If the partitions needed to execute the query are included in the plan stored in the cache, the join engine obtains the plan from the cache and executes the plan to return a result to the query. If the partitions needed to execute the query are not included in the plan stored in the cache, the join engine prepares a new plan for the superset of partitions needed to execute the new query, replaces the plan stored in the cache with the new plan and executes the new plan to return a result to the query.

The details of one or more implementations are set forth in the accompanying drawings and the description below. Other features will be apparent from the description and drawings, and from the claims.

### BRIEF DESCRIPTION OF THE DRAWINGS

FIG. 1 is an example block diagram of a database.

FIG. 2 is an example diagram of a plan having a table with four partitions joined together with a table having no partitions.

FIG. 3 is an example flowchart illustrating example operations of the system of FIG. 1.

FIG. 4 is an example flowchart illustrating example operations of the system of FIG. 1.

FIG. 5 is an example flowchart illustrating example operations of the system of FIG. 1.

### DETAILED DESCRIPTION

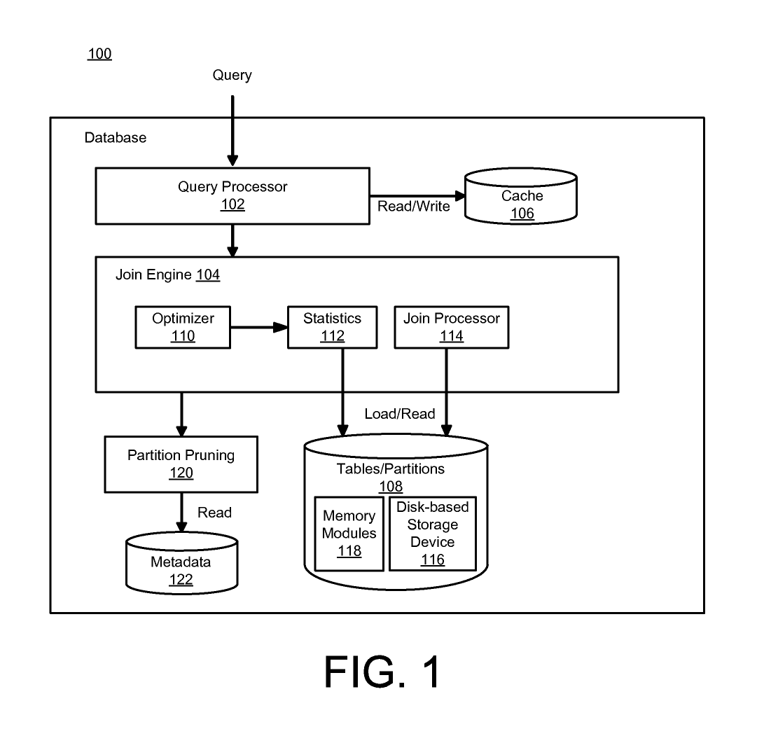

FIG. 1 is an example block diagram of a database 100. The database 100 includes a query processor 102, a join engine 104, a cache 106, and multiple tables 108. The database 100 contains data stored in the tables 108. In one example implementation, the database 100 may include an in-memory database. The database 100 receives prepared calls or queries at the query processor 102 for data stored in the tables 108 and to return a result to the received query. Prior to executing the received query, the database 100 may prepare a plan for executing the query in order to optimize the database resources and to obtain and return a result to the query in a cost-efficient and effective manner.

The tables 108 may be non-partitioned and/or partitioned. Data in the tables 108 may be stored across multiple partitions. Thus, when a query is received by the query processor 102, one or more partitions may need to be joined together in order to return a result to the query. The partitions may be stored on a single node or across multiple nodes in a distributed environment. Processing of individual partitions takes place in parallel by multiple processors, if the required tasks allow independent execution. This is especially true in distributed environments where these tasks are even being executed on different nodes. In both cases, portions of the query are being executed individually (on respective nodes) and are used to form a result.

In one example implementation, the query processor 102 may include an SQL processor. In this example, the queries received by the SQL processor may be SQL queries in the format of an SQL statement. Other types of query processors may be implemented as part of the database 100 and different query statement strings or formats may be used as appropriate with the type of query processor being implemented. With respect to FIG. 1, various examples will be discussed in terms of the query processor 100 as being implemented as an SQL processor. It is understood that these are just examples and other types of query processors and statements may be used to obtain data from the database 100.

The query processor 102 is configured to accept the query string and analyze the query string. As part of the analysis, the query processor 102 determines whether or not one or more partitions need to be joined in order to return a result to the query. If the query processor 102 determines that the query string contains at least one join, then the query processor 102 communicates the query string to the join engine 104. If the query string contains a matching string for a corresponding plan stored in the cache 106, then the query processor 102 retrieves the plan for the query string from the cache 106. The query processor 102 then also communicates the retrieved plan from the cache 106 to the join engine 104. If the query string does not contain a matching string for a corresponding plan stored in the cache 106, then the query processor 102 simply communicates the query string to the join engine 104 without sending along a corresponding plan.

The join engine 104 includes an optimizer 110, a statistics module 112 (also referred to simply as statistics 112) and a join processor 114. The join engine 104 is configured to prepare a plan for executing the query to obtain the desired data from the tables 108. The join engine 104 may prepare the plan, where the plan includes the partitions needed to fulfill the query. Returning a result to the query may include multiple phases executed by the database 100. For instance, the database 100, through the join engine 104, may have both a prepare phase and an execution phase. As discussed in more detail below, the prepare phase and the execution phase may include different steps depending on a type of approach used by the join engine 104. The prepare phase occurs prior to executing the query. The execution phase includes executing the prepared plan and may include other steps as well including pruning partitions from the plan that do not need to be included to return a result to the query.

The optimizer 110 is configured to determine the tables in the use for the received query. The optimizer 110 analyzes the received query on the database 100 and examines the search conditions presented in the query in order to optimize the access to the data. The optimizer 110 may use a cost determination and statistics 112 to select an optimal search strategy for accessing the data stored in the tables 108. The statistics 112 obtain basic information related to the tables 108. In order to determine the statistics and to provide the information to the optimizer 110, the statistics 112 loads the tables and/or partitions of the tables into memory. The statistics include the size of the tables as well as cardinalities and number of distinct values. Other table statistics also may be obtained by the statistics 112 as needed by the optimizer 110. The optimizer 110 prepares a plan to join the multiple partitions using paths between the join partitions based on the statistics provided by statistics module 112.

The plan prepared by the optimizer 110 may be in the form of a graph. The graph may include the partitions to be joined as objects in the graph and may include paths linking the objects together to indicate how the partitions are to be joined to one another.

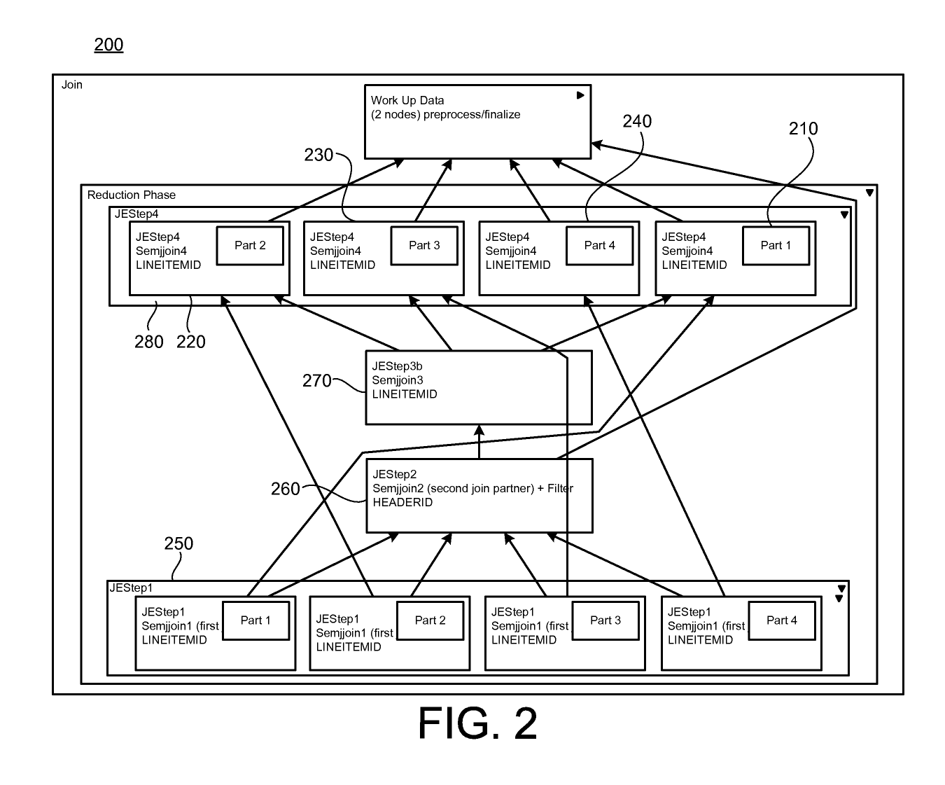

Referring to FIG. 2, a plan 200 illustrates how two tables (“LINEITEM”, “HEADER”) are joined in a four-step processing using a semijoin algorithm. In this example, table “LINEITEM” is split into 4 partitions (210-240) and “HEADER” is not partitioned. The first step 250 identifies the partitions of “LINEITEM” needed to obtain send values (or value ids) of the join attribute to the “HEADER” table. The second step 260 and the third step 270 illustrate the steps necessary on the “HEADER” table to determine the joinable rows, based on the “LINEITEM” values sent from all 4 partitions. The fourth step 280 illustrates the last step of the semijoin algorithm on all parts of the “LINEITEM” table to determine joinable rows on “LINEITEM” based on the semijoin reduction from HEADER. While the plan 200 includes four partitions, it is understood that this is merely a simple example and that a plan may include many multiple partitions.

Referring back to FIG. 1, the plan prepared by the optimizer 110 may be written to the cache 106 through the query processor 102. In this manner, the plan stored in the cache 106 may be reused when a matching query string is later received by the query processor 102. The plan may be reused and eliminate the prepare phase for performing the query and instead execute the plan that is already in place. As discussed in more detail below, a stored plan may be overwritten when the join engine 104 prepares a more inclusive plan or prepares a plan that includes not only the partitions included in the stored plan but also additional partitions.

The join processor 114 performs the actual joining of the tables and/or partitions of the tables needed to provide a result to the query according to the plan provided by the optimizer 110. Both the join processor 114 and the statistics 112 access the tables 108 to perform their functions. Ideally, in some implementations, it may be desirable to load and read as few partitions as possible. It may be undesirable to load old data that is not needed to return a result for the query, especially if the partitioned data is stored on disk-based storage device 116 and has to be loaded first into the in-memory modules 118. An approach to minimize the loading and reading of partitions stored on disk taste storage device 116 is discussed in more detail below.

The database 100 also includes a partition pruning module 120. The partition pruning module 120 is configured to analyze the WHERE clauses in the query statement to determine which partitions do not contribute to the query result and may hence be removed from the previously prepared plan prior to execution by the join processor 114. In this manner, the partition pruning module 120 reports to the join engine 104 after a plan has been prepared as to which partitions may be removed from the plan. The join processor 114 creates a mask in order to remove the partitions not needed for the execution of the query. The mask is applied over the prepared plan to virtually remove the paths from partitions that are not needed for the execution. In this manner, while the plan includes the partitions, the masks operates to virtually remove the paths from the graph of the plan such that the join processor 114 ignores those partitions because the paths connecting the partitions have been removed with the overlay of the mask onto the plan. This way it is not required to copy the original cached plan objects in memory.

As mentioned above, partition pruning may be accomplished once the plan has been prepared by the join engine 104. In more detail and also referring to FIG. 2, one technique may be implemented to prune partitions after a plan has been prepared. When a query string is received by the query processor 102 and no plan exists for the query string in the cache 106, the query processor 102 passes the query to the join engine 104 when it includes joins of partitions. The join engine 104 through the optimizer 110 determines the tables that are involved with the query. Then, the join engine 104 considers all of the partitions for that table. For example, with respect to table “LINEITEM” of FIG. 2 having the four partitions 210-240, the join engine 104 prepares a plan for all four partitions, whether those partitions are needed or not for returning the query results. The optimizer 110 obtains the statistics 112 for all four partitions 210-240. The join processor 114 optimizes the plan according to the obtained statistics 112. The plan is then stored in the cache 106.

During execution of the query and prior to returning the result for the query, the partition pruning module 120 analyzes one or more clauses of the query to determine which of the join partitions to prune from the plan. For example, the partition pruning module 120 looks for WHERE and WITH RANGE RESTRICTION clauses to determine which partitions may not be needed during the execution phase in order to return a meaningful result to the query. The partition pruning module 120 may use metadata 122 to make the determination as to which partitions to prune. Various kinds of partitioning exist, for example Range Partitioning. With Range partitioning, individual partitions have min and max values that define the min and max values for a given “partitioning column” that may be stored in a partition. These values are than compared with the WHERE clauses on that partitioning column, if existing. As an example, partition 1 (210) may store values from 1000 to 1999 and partition 2 (220) values from 2000 to 2999 for column ID. If a WHERE clause is provided in the query string, e.g. “WHERE ID=1500”, partition pruning module 120 will communicate that only partition 1 (210) may contribute to the query result.

A database implementation 100 may have a special partitioning concept for tables with current and historical data, so-called “aging tables”. In an example implementation, such tables may have a Range partitioning on a date column with one partition per year. The values of this column have a semantic “close date” meaning from a business perspective. As an example, if an order is closed, that close date is set in this date column. A special WITH RANGE RESTRICTION clause may be used generically for SQL statements to specify for all tables of this kind used in a given query, how far into the past a query shall go. In the example above, two aging tables might be joined and a WITH RANGE RESTRICTION being present. Assuming the value of the WITH RANGE RESTRICTION is set to 2009, this shall indicate that the database considers this as a filter on the aging tables so that all data>=2009 is considered. This means that the partition pruning module 120 communicates that all historical partitions>=2009 and the current partition are relevant.

In one example, a WHERE clause in the query string may indicate that only partition 1 (210) and partition 2 (220) are needed to execute the query and that partition 3 (230) and partition 4 (240) may be pruned because they are not needed to execute the query string. The partition pruning module 120 communicates this information to the join engine 104. The join processor 114 creates a mask to overlay the plan to remove the paths connecting partition 3 230 and partition 4 240 the other two partitions 210 and 220. In this manner, when the join processor 114 executes the plan the pruned partitions, partition 3 (230) and partition 4 (240), are not used during the execution.

In one example implementation, during the prepare phase and prior to the execution of the query, pruning may be performed to remove partitions not needed in the plan based on analysing the query string for constant WHERE predicates. In this manner, partitions indicated as not needed based on the constant WHERE predicates will not be included in the prepared plan. This way constant WHERE clauses yield that statistics are not being collected by the statistics module 112 that might cause loading partitions from disk.

In this example, one advantage is that the plan is stored in the cache 106 and may be reused to execute subsequent queries without having to create a new plan. Also it is not needed to create a copy of the plan for the execution of the plan by the join processor 114. Instead, the mask created by the join processor to prune the partitions that are not needed during the execution, are applied virtually to the original and cached plan reference. The plan is not modified in any way. This saves future processing time and by not having to copy the plan during the process.

In the example discussed above where partitions are pruned after the plan has been prepared, one issue is that during the prepare phase all of the partitions are loaded into the memory modules 118 as part of preparing the plan. As seen in this example, it was not necessary to include all of the partitions in the plan because only two of the four partitions are needed to execute the query string by the join processor 114. For instance, the partitions for the “LINEITEM” table of FIG. 2 may be stored in disk-based storage 116 such that it is desirable to only load partitions into the memory modules 118 when necessary to execute a query. Thus, if the partitions are not needed for returning a result to the query, then it is desirable to leave those partitions in the disk-based storage device 116 and not read those partitions into the memory modules 118. Thus, another approach may be used to limit or reduce the partitions that are read into the memory modules 118 during the plan preparation phase prior to executing the plan.

In one example implementation, an approach may be used to prune partitions based on analysing query strings containing certain types of clauses. For example, a query string may include a WITH RANGE RESTRICTION clause that specifies age criteria. The partitions for the tables 108 may be partitioned based on aging criteria such that older partitions are stored in disk-based storage device 116 and only more recent partitions are stored in the memory modules 118. Thus, it is desirable to only load the historical partitions from the disk-based storage device 116 when needed to prepare a plan because the partitions include data needed to respond to the query.

The partition pruning module 120 analyzes one or more clauses of the query so that the optimizer 110 may determine which of the partitions to include in a plan for a join using paths between the plan operations that are eventually executed by the join processor 114. The optimizer only gets statistics for those partitions that are to be included in the plan. The plan is optimized by the optimizer 110 according to the obtained statistics and executed by the join processor 114. The join engine 104 saves and stores the plan along with the information which partitions were considered in the cache 106. In this manner, the stored plan may be used for subsequent queries that require the use of the same or fewer partitions that were used to prepare the plan.

When a subsequent query is received by the query processor 102, the query processor 102 checks the cache 106 to determine if the plan stored in the cache may be used. For instance, if the query string includes a WITH RANGE RESTRICTION clause and all of the needed partitions are included in the plan, then the join engine proceeds to execute the plan in conjunction with the partition pruning module 120 analyzing where clauses to prune any unneeded partitions using a mask over the plan, as discussed above. However, if the query string includes a range of partitions that is not included in the plan then a new plan needs to be created. The new plan is created as discussed above and after created overwrites the old plan in the cache 106. In this manner, the new plan is more inclusive of additional partitions and thus is a better plan than the previous plan. The new plan may be pruned during the execution phase by using the partition pruning module 120 by creating the mask to overlay on the new plan to eliminate partitions not needed for the execution of a particular query string. This works in the described manner because WITH RANGE RESTRICTION may have a date as parameter, e.g. WITH RANGE RESTRICTION (‘2009-01-01’), and everything greater than equals 2009 is included. Since dates form a timeline and always a “greater than equals” semantics is applied, it is only possible that more partitions are to be considered but not that some partitions have to be removed in the middle.

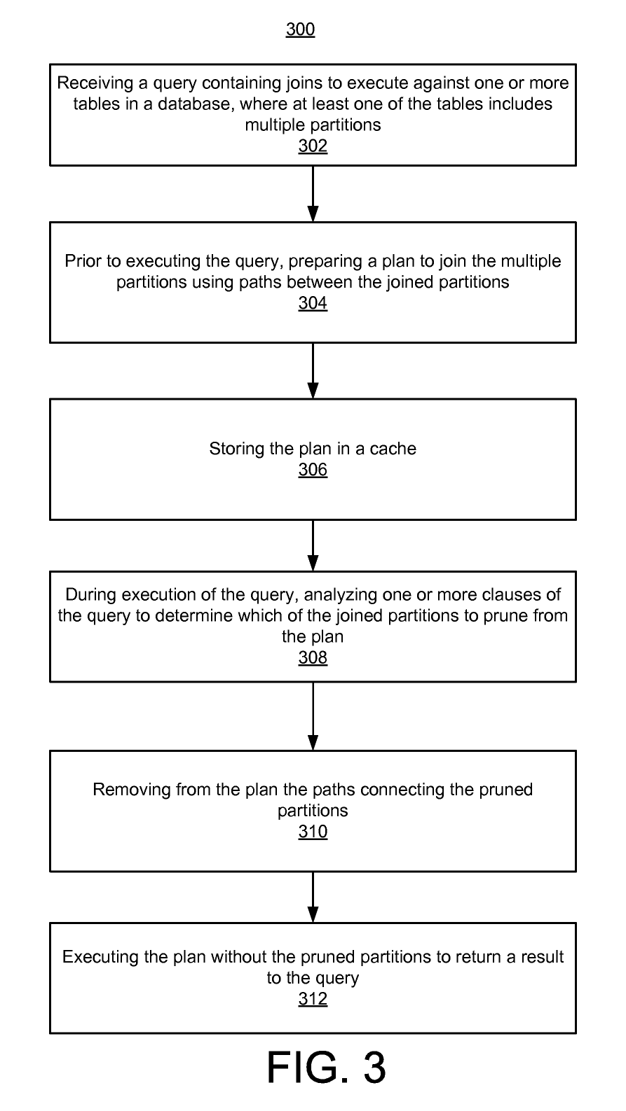

Referring to FIG. 3, an example process 300 illustrates operations of the database 100 of FIG. 1. Process 300 includes receiving a query containing joins to execute against one or more tables in a database, where at least one of the tables includes multiple partitions (302). For example, the database 100 through the query processor 102 is configured to receive a query containing joins to execute against one or more tables 108, where at least one of the tables 108 includes multiple partitions.

Process 300 includes prior to executing the query, preparing a plan to join the multiple partitions using paths between the joined partitions (304). For example, the join engine 104 is configured to prepare a plan to join the multiple partitions using paths between the joined partitions.

Process 300 includes storing the plan in a cache (306). For example, the plan created by the join engine 104 may be stored in the cache 106. During execution of the query, process 300 includes analyzing one or more clauses of the query to determine which of the joined partitions to prune from the plan (308). For example, the partition pruning module 120 is configured to analyze the clauses of the query to determine which of the joined partitions to prune from the plan.

Process 300 includes removing from the plan the paths connecting the pruned partitions (310). For instance, the join engine 104 is configured to remove the paths from the plan that connect the pruned partitions based on the analysis by the partition pruning module 120. The plan is executed without the pruned partitions to return a result to the query (312). The join engine 104 executes the plan without the pruned partitions to return a result to the query through the query processor 102.

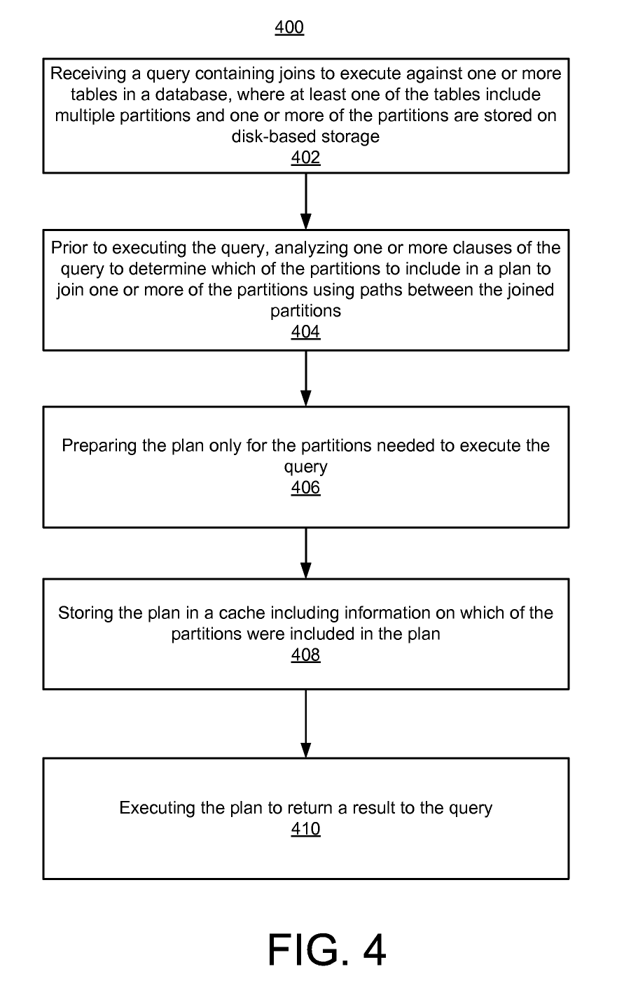

Referring to FIG. 4, an example process 400 illustrates operations of the database 100 of FIG. 1. Process 400 includes receiving a query containing joins to execute against one or more tables in a database, where at least one of the tables includes multiple partitions and one or more of the partitions are stored on disk-based storage (402). For example, the database 100 through the query processor 102 is configured to receive a query containing joins to execute against one or more tables 108, where at least one of the tables 108 includes multiple partitions and one or more of the tables are stored on disk-based storage device 116.

Process 400 includes prior to executing the query, analyzing one or more clauses of the query to determine which of the partitions to include in a plan to join one or more of the partitions using paths between the joined partitions (404). For example, the join engine 104 may analyze one or more of the clauses of the query to determine which of the partitions to include in a plan to join one or more of the partitions using paths between the joined partitions.

Process 400 includes preparing the plan only for the partitions needed to execute the query (406). For example, the join engine 104 prepares the plan only for the partitions needed to execute the query. Process 400 includes storing the plan in a cache including information on which of the partitions were included in the plan (408). The join engine 104 stores the plan in a cache including information on which of the partitions were included in the plan. Process 400 includes executing the plan to return a result to the query (410). The join engine 104 executes the plan and returns the result to the query through the query processor 102.

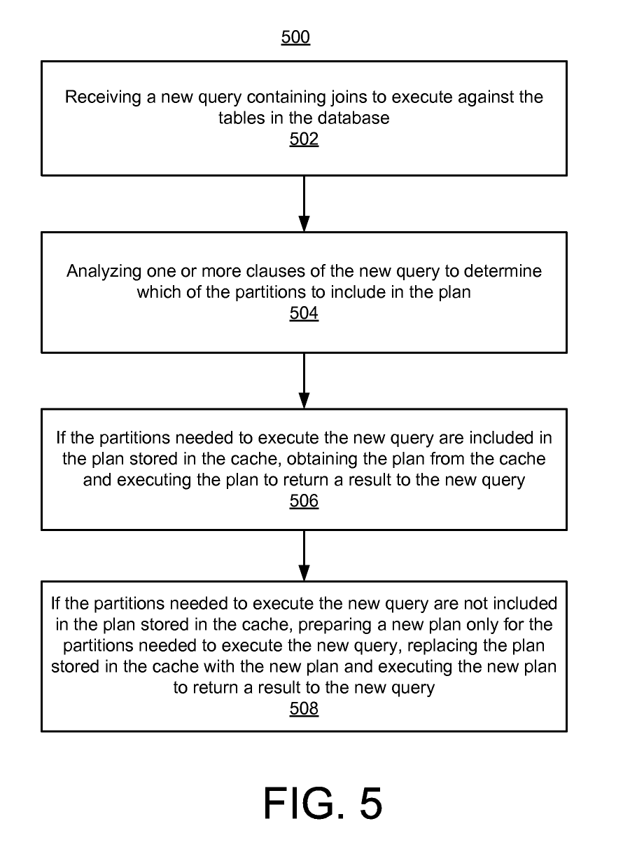

Referring to FIG. 5, an example process 500 illustrates example operations of the database 100 of FIG. 1 for when new queries are received after a plan has been created as described above with respect to process 400 of FIG. 4. Process 500 includes receiving a new query containing joins to execute against the tables in the database (502). For example, the database 100 through the query processor 102 is configured to receive the new query containing joins to execute against the tables 108. For these subsequent queries that are received, the process 500 includes analyzing one or more clauses of the new query to determine which of the partitions to include in the plan (504). For example, the join engine 104 may analyze one or more of the clauses of the new query to determine which of the partitions to include in the plan.

If the partitions needed to execute the new query are included in the plan stored in the cache, the plan is obtained from the cache and the plan is executed to return a result to the new query (506). For example, if the partitions needed to execute the new query are included in the plan stored in the cache 106, the join engine 104 obtains the plan from the cache 106 and executes the plan to return a result to the new query.

If the partitions needed to execute the new query are not included in the plan stored in the cache, a new plan is prepared only for the partitions needed to execute the new query, the plan stored in the cache is replaced with the new plan and the new plan is executed to return a result to the new query (508). For example, if the partitions needed to execute the new query are not included in the plan stored in the cache 106, the join engine 104 prepares a new plan and replaces the old plan with the new plan in the cache 106. Then, the join engine 104 executes the new plan to return a result to the new query.

The database 100 of FIG. 1 and the processes 300, 400 and 500 of FIGS. 3-5 have at least the technical effects of increasing the speed of query processing by the database 100 and returning results to queries in a faster manner. The above database and processes also have at least the technical effects of increasing the database 100 performance by having to perform fewer loads of statistics and partitioned data from disk-based storage to in-memory modules.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for preparing and executing a plan for a query containing joins against one or more tables having multiple partitions, the method comprising:
receiving a query containing joins to execute against one or more tables in a database, wherein at least one of the tables includes multiple partitions;
prior to executing the query, preparing a plan to join the multiple partitions using paths between the joined partitions;
storing the plan in a cache;
during execution of the query, analyzing one or more clauses of the query to determine which of the joined partitions to prune from the plan;
removing from the plan the paths connecting the pruned partitions; and
executing the plan without the pruned partitions to return a result to the query.

2. The computer-implemented method as in claim 1, further comprising:
receiving a new query containing joins to execute against the tables in the database;
retrieving the plan from the cache;
during execution of the new query, analyzing one or more clauses of the new query to determine which of the joined partitions to prune from the plan;
removing from the plan the paths connecting the pruned partitions; and
executing the plan without the pruned partitions to return a result to the new query.

3. The computer-implemented method as in claim 1, wherein removing from the plan the paths connecting the pruned partitions comprises creating a mask identifying the paths to remove from the plan for the pruned partitions and applying the mask to the plan to remove from the plan the paths connecting the pruned partitions.

4. The computer-implemented method as in claim 3, wherein applying the mask to the plan to remove from the plan the paths connecting the pruned partitions is performed without modifying the plan.

5. The computer-implemented method as in claim 1, wherein removing from the plan the paths connecting the pruned partitions is performed without making a copy of the plan.

6. The computer-implemented method as in claim 1, further comprising prior to executing the query, analyzing constant WHERE predicates of the query to determine which of the partitions to exclude from the plan prior to joining the partitions.

7. The computer-implemented method as in claim 1, wherein preparing a plan to join the multiple partitions comprises:
analyzing one or more clauses of the query to determine which of the partitions to include in the plan; and
preparing the plan only for the partitions needed to execute the query.

8. The computer-implemented method as in claim 7, wherein analyzing the one or more clauses of the query comprises analyzing at least one WITH RANGE RESTRICTION clause to determine which of the partitions to load in memory from disk storage for obtaining statistics to prepare the plan.

9. The computer-implemented method as in claim 8, wherein one or more of the partitions are stored on disk-based storage.

10. The computer-implemented method as in claim 1, wherein the database includes an in-memory database.

11. A computer-implemented method for preparing and executing a plan for a query containing joins against one or more tables having multiple partitions, wherein one or more of the partitions are stored on disk-based storage, the method comprising:
receiving a query containing joins to execute against one or more tables in a database, wherein at least one of the tables include multiple partitions and one or more of the partitions are stored on disk-based storage;
prior to executing the query, analyzing one or more clauses of the query to determine which of the partitions to include in a plan to join one or more of the partitions using paths between the joined partitions;
preparing the plan only for the partitions needed to execute the query;
storing the plan in a cache including information on which of the partitions were included in the plan; and
executing the plan to return a result to the query.

12. The computer-implemented method as in claim 11, wherein preparing the plan comprises:
obtaining statistics only for the partitions needed to execute the query; and
optimizing the plan based on the obtained statistics.

13. The computer-implemented method as in claim 11, further comprising:
receiving a new query containing joins to execute against the tables in the database;
analyzing one or more clauses of the new query to determine which of the partitions to include in the plan;
if the partitions needed to execute the new query are included in the plan stored in the cache, obtaining the plan from the cache and executing the plan to return a result to the new query; and
if the partitions needed to execute the new query are not included in the plan stored in the cache, preparing a new plan only for the partitions needed to execute the new query, replacing the plan stored in the cache with the new plan and executing the new plan to return a result to the new query.

14. The computer-implemented method as in claim 13, wherein if the partitions needed to execute the new query are included in the plan, the method further comprising:
during execution of the new query, analyzing one or more clauses of the new query to determine which of the joined partitions to prune from the plan;
removing from the plan the paths connecting the pruned partitions; and
executing the plan without the pruned partitions to return a result to the new query.

15. The computer-implemented method as in claim 11, wherein the database includes an in-memory database.

16. A system for preparing and executing a plan for a query containing joins against one or more tables having multiple partitions, wherein one or more of the partitions are stored on disk-based storage, the system comprising:
a database comprising one or more tables having multiple partitions, the database further comprising:
memory modules storing one or more of the multiple partitions of the tables;
a disk-based storage device storing one or more of the multiple partitions of the tables,
a query processor configured to receive a query containing joins to execute against at least one of the tables;
a plan cache that is operably coupled to the query processor and that is configured to store a plan to join one or more of the partitions using paths between the joined partitions; and
a join engine that is operably coupled to the disk-based storage, the memory modules, and the query processor, wherein the join engine is configured to:
analyze one or more clauses of the query to determine which of the partitions are needed to execute the query,
if the partitions needed to execute the query are included in the plan stored in the cache, obtain the plan from the cache and execute the plan to return a result to the query, and
if the partitions needed to execute the query are not included in the plan stored in the cache, prepare a new plan only for the partitions needed to execute the new query, replace the plan stored in the cache with the new plan and execute the new plan to return a result to the query.

17. The system of claim 16, wherein if the partitions needed to execute the query are included in the plan, the join engine is further configured to:
during execution of the query, analyze one or more clauses of the query to determine which of the joined partitions to prune from the plan;
remove from the plan the paths connecting the pruned partitions; and
execute the plan without the pruned partitions to return a result to the query.

18. The system of claim 17, wherein the join engine is configured to create a mask identifying the paths to remove from the plan for the pruned partitions and apply the mask to the plan to remove from the plan the paths connecting the pruned partitions.

19. The system of claim 18, wherein the join engine is configured to apply the mask to the plan to remove from the plan the paths connecting the pruned partitions without modifying the plan.

20. The system of claim 16, wherein the join engine is configured to remove from the plan the paths connecting the pruned partitions without making a copy of the plan.
